(19) United States
(12) Patent Application Publication
(10) Pub. No.: US 2019/0308162 A1
(43) Pub. Date: Oct. 10, 2019

(54) Evaporation-Resistant Coating

(71) Applicant: Powdermet, Inc., Euclid, OH (US)

(72) Inventors: Andrew Sherman, Mentor, OH (US); Haixong Tang, Euclid, OH (US); Nicholas Farkas, Euclid, OH (US)

(21) Appl. No.: 16/448,371

(22) Filed: Jun. 21, 2019

Related U.S. Application Data
(62) Division of application No. 15/964,257, filed on Apr. 27, 2018.
(60) Provisional application No. 62/506,133, filed on May 15, 2017.
(60) Provisional application No. 62/561,817, filed on Sep. 22, 2017.

(51) Int. Cl. B01J 19/16

(52) U.S. Cl. CPC B01J 19/16

(57) ABSTRACT

An improved evaporation barrier that incorporates multifunctional particles to reduce evaporation. The improved evaporation barrier is typically in liquid form. The improved evaporation barrier is formed of a mixture of one or more alkanes and a reflective and/or non-reflective material. The improved evaporation barrier can optionally include a nonvolatile oil in combination with the alkane. The reflective and/or non-reflective material can be optionally surface functionalized. The improved evaporation barrier can optionally include a hydrophobic compound.

The present invention is a divisional of U.S. application Ser. No. 15/964,257 filed Apr. 27, 2018, which in turn claims priority on U.S. Provisional Application Ser. No. 62/506,133 filed May 15, 2017 and 62/561,817 filed Sep. 22, 2017, both of which are incorporated herein by reference.

The invention relates to an improved evaporation-resistant coating for use in water loss prevention from large reservoirs or ponds, and particularly to evaporation-resistant coating for use in preventing water loss from large reservoirs or ponds used for storing water and brines that are to be used in onshore oil and gas operations.

### BACKGROUND OF THE INVENTION

Oil and gas completion operations use large volumes of water mixed with chemicals, such as CaBr₂, NaCl and KCl, to control density, fluidity, and other properties to safely drill wells, and then pump such water into the formation under pressure to fracture formations and enhance the recovery of oil. Hundreds of thousands of barrels of water are used in each well, and hundreds of wells may be drilled in a given location. Many of these oil and gas operations are carried out in remote, dry locations such as West Texas, Oklahoma, or the Middle East, where access to water, particularly fresh water, is limited, and where fresh water must be transported in, at costs that can reach several dollars per barrel or more.

The water used in these oil and gas operations is typically stored in manmade ponds, basins, or above-ground storage containers, and is pumped from such ponds or above-ground storage containers to the well. A typical pond might be 250 feet in diameter and store several acre-feet of water. During dry summer months, these ponds can lose ¼ acre-feet of water per day to evaporation. To maintain salinity and not change chemistry of the stored water, the stored water must be replaced with freshwater, which can be at high expense in some locations.

Many options have been tried, with only moderate economic success, to reduce and prevent evaporation of the water in the ponds or open storage containers. The use of physical coverings such as tarps is difficult on large ponds; such coverings are costly to acquire and deploy and are subject to problems from wind and physical damage. Also, over time, these covers can be covered with sand/dust, thus causing the covering to sink into the pond and thereby impair the function of the covering. Such coverings also tend to pool water on their surface in the event of a physical breach in the covering or from rainstorms, thus creating many operational headaches during removal or positioning in the pond.

Other options have also been used to limit evaporation from ponds or open storage containers such as adding ping pong balls or other floating barriers on the top surface of the water in the pond or storage container. These floating barriers tend to be costly, difficult to transport and manage, and can be removed or shoved aside in large ponds or reservoirs in stiff winds common in places such as West Texas, thus compromising the effectiveness of such floating barriers.

Another option used to limit evaporation from ponds or open storage containers is the addition of high molecular weight alcohols or other water additives to the water, which additives can segregate to the surface and reduce evaporation losses. While such additives are effective at reducing evaporation losses by up to 50-65%, these additives lose their effectiveness after a few days, and must be continuously added to the water. The use of long-chain, solid, aliphatic fatty alcohols, particularly of chain length C₁₆ and C₁₈, (commonly known as cetyl alcohol and stearyl alcohol, respectively) are known in the prior art for suppressing water evaporation. However, issues with dispensing these materials in the water present hurdles to their use in practice under actual use conditions. Attempts to overcome these hurdles have involved a number of approaches. The prior art teaches the need to combine these materials with solvents and dispersants or spreading agents to make their use practical under actual use conditions. These prior art compositions involve heating, combining, and dispensing materials at high temperatures (between about 70° C. to about 100° C.).

U.S. Pat. Nos. 4,162,990 and 4,250,140 teach that the smallest chain length that can seriously be regarded as an evaporation retardant is C₁₆.

U.S. Pat. No. 3,528,764 to Reiser discloses a method and apparatus for retarding water evaporation from water surfaces through the use of solid fatty alcohols delivered as a dispersion. Alternatively, an emulsion can be formed from the dispersion by including a surfactant such as ethoxy derivatives of fatty alcohols. Reiser specifically indicates a preference to use a fatty alcohols having from 16 to 18 carbon atoms.

U.S. Pat. No. 6,303,133 to O'Brien discloses a composition that forms a monolayer to suppress water evaporation, comprising an aliphatic alcohol component having from C₁₂-C₂₄ and powdered calcium hydroxide. Cetyl alcohol and octadecanol can be used; cetyl alcohol (hexadecanol) having a chain length of C₁₆ is preferred.

U.S. Pat. No. 4,162,990 to Rowlette discloses using a polyethylene glycol that is soluble in both water and the fatty alcohol (such as docosanol, docosanoic acid or octadecanol) as a spreading agent for the fatty alcohol on the surface of a body of water. The particles are mixed with particles of a filler material capable of generating a gas upon contact with water.

U.S. Pat. No. 4,250,140 to Rowlette discloses using a polyethylene glycol, such as those in the CARBOWAX® series (Registered trademark of Union Carbide Chemicals & Plastics Technology Corp., Danbury, Conn.), as a spreading agent for a film-forming agent. Rowlette teaches that C₁₆ is the smallest chain length that can seriously be regarded as an effective evaporation retardant.

U.S. Pat. No. 3,531,239 to Rowlette teaches that various fatty alcohols, such as octadecanol, hexadecanol, nonadecanol, and pentadecanol, could be used as evaporation retardants for water, although Rowlette states that a chain length from C₁₆ to C₁₈ is generally preferred.

U.S. Pat. No. 3,415,614 to Egan discloses the addition of a heterocyclic, 5-membered ring compound, one of which is oxygen, to at least one solid aliphatic alcohol ranging from C₁₂-C₂₀, to form a solid, self-dispersing composition. The aliphatic alcohols include myristyl, cetyl and stearyl alcohols, and mixtures thereof. The most preferred composition comprises cetyl and stearyl alcohols which retards evaporation by about 30-40%.

U.S. Pat. No. 3,391,987 to Myers discloses compositions using water-soluble saccharides as carriers for the fatty alcohols where hexadecanol and octadecanol with chain lengths C₁₆ and C₁₈ are especially preferred. Unsaturated alcohols such as oleyl alcohol may be used, but are not preferred.

U.S. Pat. No. 3,257,162 to Cox discloses glycol esters, glycol amides and ethoxylated amides and ethoxylated derivatives thereof that are effective in retarding evaporation of aqueous solutions of normally volatile organic substances.

U.S. Pat. No. 3,959,154 to Cox discloses agents to retard the evaporation of ammonia and amines from essentially aqueous solutions by adding thereto an alkyl ether having the formula: R—(O[CH₂]_{y})—R′ where R is an alkyl group containing from 8 to 30 carbon atoms, and R′ is an —OH or —NH₂ group, y is an integer of 2 to 4; and n is an integer of 1 to 10. Cox notes that the utility of these compositions is predicated on the fact that they effect the evaporation of dissolved ammonia or amines to a far larger extent than their effect on the evaporation of water.

U.S. Pat. No. 2,903,338 to Dressier discloses the use of finely divided and wetted/suspended fatty acid alcohols, preferably C₁₆ to C₁₈, dispersed in water or emulsified with sodium lauryl sulfate or sodium dodecylbenzene sulfonate to form a film that leads to a reduction in water loss by evaporation.

U.S. Pat. No. 3,036,880 to Malkemum discloses the use of ethylene glycol and propylene glycol monoesters of long chain fatty acids to form films on the surface of water. Malkemum teaches that the fatty acid must have at least 14 carbon atoms since esters from the lower acids do not appear to offer any advantages. Benzene is the preferred solvent.

U.S. Pat. No. 3,146,059 to Suzuki et al. disclose the use of derivatives of aliphatic alcohols with carbon chain lengths of 22 to 16 or docosanol to cetanol in compositions for retarding water evaporation. The claims are addressed to longer chain structures, having the general formula: CH₃—(CH₂)m-O—(CH₂—CH₂—O)n-H where in is 15-21; and n is 1-5, which may be mixed with a compound such as urea, salts of carboxymethylcellulose or alginic acid. Fatty alcohol derivatives of this composition with 1 mole of ethylene oxide showed an average reduction in the evaporation rate of water of 56 wt. %, 22 wt. %, 6 wt. % respectively for C₂₂, C₁₈, and C₁₆. Furthermore, the evaporation rate reduction decreased from an average of 56 wt. % for 1 mole of ethylene oxide to about 9 wt. % for 5 moles of ethylene oxide. Taken together, these results clearly indicate that the expected effect on the evaporation rate of water for ethoxylates of fatty alcohols with a carbon chain length less than C₁₆ would be close to zero. Thus, it would be very surprising and unexpected that a fatty alcohol ethoxylate with a carbon chain length of C₁₂ and 2 moles of ethylene oxide, such as Laureth-2, would have any effect on the evaporation rate of water.

U.S. Pat. No. 3,241,908 to Mazur discloses a method for preparing a monomolecular film former for controlling evaporation from water surfaces, using fatty acid alcohols such as n-hexadecanol and n-octadecanol, which show a 25-35% reduction in the evaporation rate of water.

U.S. Pat. No. 3,437,421 to Harwood discloses the use of long-chain aliphatic alcohols as agents for retarding water evaporation and a method by which solid long-chained alcohols are liquefied by heating and then sprayed onto the surface of a body of water. The preferred compounds were the C₁₆ and C₁₈ compounds hexadecanol and octadecanol; unsaturated alcohols, such as oleyl alcohol, had a lower efficiency than the saturated alcohols.

U.S. Pat. No. 3,650,980 to Gothel et al. discloses a film forming composition to retard evaporation loss that comprises a higher alkyl alcohol and up to 3 wt. % of an ortho-silicic acid ester of an ethoxylated alcohol. Ethoxylated lauryl- as well as stearyl-alcohols are stated to be of restricted applicability as non-ionic surfactants.

U.S. Pat. No. 4,172,058 to Hall discloses the use of a mixture of hexadecanol and octadecanol, both as a mixture of liquids, or a dry mixture thereof, as a composition to retard evaporation of fluid from an aqueous mixture containing “H-SPAN”, a hydrolyzed starch-polyacrylonitrile graft copolymer.

U.S. Pat. No. 4,707,359 to McMullen discloses the use of fatty acid alcohols in conjunction with an insecticide to form a layer on a water surface and kill insects, such as mosquitoes. The particular compounds are described in Great Britain Pat. No. 1,557,804A, with the composition including an oleyl poly-ethoxy, poly-propoxy mixed ether. The composition may include a solvent, such as water, kerosene, hexane deiselene, heptane, and gas oil.

U.S. Pat. No. 4,932,994 to Koester et al. disclose a paraffin-containing aqueous dispersion or a self-emulsifying solution in an organic solvent, to form films on the surface of water.

PCT WO 91/13336 to Phillip et al. discloses controlled evaporation by covering the aqueous reaction mixture with an evaporation inhibitor liquid which was immiscible in the aqueous phase and had a density less than the aqueous phase. In a preferred embodiment, the evaporation inhibitor liquid is a non-aromatic hydrocarbon having from 6 to 18 carbons, preferably pentadecane (mineral oil). The evaporation inhibitor liquid covers the surface of the reaction mixture, preventing evaporation of the reagents.

Improvements such as those described in U.S. Pat. No. 5,549,848 to Zeheb et al. include the addition of a non-volatile oil such as silicone oil or vegetable oil.

In previously disclosed evaporation inhibition liquids, water temperatures are increased upon exposure to solar energy, creating the need for shading the pond, or creating a thermal spiral in which suppressing evaporative cooling increases the temperature to the point at which the inhibition liquid starts to evaporate, eventually causing elimination of the protective function.

In view of the current state of the art, there is a need for an improved composition to limit evaporation from ponds or open storage containers.

### SUMMARY OF THE INVENTION

The present invention pertains to the development of an improved evaporation barrier for water. The improved evaporation barrier can also optionally have a reflective function.

In one non-limiting aspect of the present invention, there is provided an improved evaporation barrier that incorporates multifunctional particles to improve the evaporation barrier. Extending the life and stability of the improved evaporation barrier of the present invention is accomplished through the addition of impermeable solid material, such as, but not limited to, powder, flakes or microballoons or microballs.

In another non-limiting aspect of the present invention, the improved evaporation barrier can be configured to inhibit or prevent plugging of pores when the improved evaporation barrier of the present invention is used in oil and gas operations. In one non-limiting embodiment, when the improved evaporation barrier includes powder or flakes. The powder or flakes can be nano-sized (having one or more dimensions that is very small (e.g., 1 micron or less), or be stable dispersions of liquid phases. The powder or flakes (e.g., magnesium alloy, aluminum-gallium alloy) can optionally be degradable upon exposure to brine. The powder or flakes can optionally include metallized polymer flakes or particles, engineered reflective pigments, and/or other particles. The powder or flakes can optionally improve the evaporation barrier of the present invention by reducing the solar heat flux entering the body of water, thereby reducing the water temperature and preventing significant temperature rises that would occur as natural evaporative cooling is suppressed.

In another non-limiting aspect of the present invention, the improved evaporation barrier is formed of an impermeable solid material (e.g., glass or polymeric flakes [glass flake, ceramic flake, and/or polymeric flake (density higher than water); glass microballoon and/or microball, ceramic microballoon and/or microball, or polymeric microballoon and/or microball (density lower than water)], glass, ceramic, or polymeric microballoons and/or microballs, silica, mica, or other translucent or transparent particle) that is coated with a water-insoluble liquid. The average particle size of the impermeable solid material is generally very small (e.g., 1 micron or less), and typically is less than 0.5 microns. The water-insoluble liquid generally has a density that is less than 1 g/cc, and typically 0.1-0.99 g/cc (and all values and ranges therebetween). The water-insoluble liquid generally has a vapor pressure below 0.1 torr at 80° C., and typically 0.0001-0.099 torr at 80° C. (and all values and ranges therebetween). The improved evaporation barrier of the present invention generally has a density that is less than 1 g/cc, and typically 0.1-0.99 g/cc (and all values and ranges therebetween) such that the improved evaporation barrier floats at or near the top surface of a reservoir or pond.

The evaporation barrier of the present invention optionally has the additional functionality of improved degradability, antibiological properties, and crosslinking or physical stabilization for the film particle additions. By inhibiting or preventing solar energy from reaching the aqueous media, the growth of algae and other biologic contamination is inhibited or prevented, thereby decreasing the need for chemicals such as bleach or chlorine, and reducing pumping and other energy waste or downtime due to filters or other cleaning systems.

In contrast to the prior art evaporation barrier compositions, the improved evaporation barrier of the present invention can utilize polyoxyethylene alkyl ethers with carbon chain lengths less than C₁₆ as the active agent. For example, polyoxyethylene (2) lauryl ether is a polyoxyethylene lauryl ether having a carbon chain length of C₁₂ with 2 moles of ethylene oxide which performs unexpectedly well for suppressing water evaporation and heat loss. Furthermore, because the improved evaporation barrier is a liquid at ambient conditions and is self-dispersing, it can be used as is, without the need for any further processing, without the need for any added solvents, carriers, dispersants or spreading agents, and without the need for any specialized equipment for application. The fatty alcohol ethoxylate used in the improved evaporation barrier can be delivered in one of several forms: a neat liquid, a solution, or a dispersion in an appropriate solvent or carrier, without the need of any additional dispersant or spreading agent. The fatty alcohol ethoxylate in the improved evaporation barrier is from about 0.1 wt. % to about 90 wt. % (and all values and ranges therebetween). In another embodiment, fatty alcohol ethoxylate in the improved evaporation barrier is from about 0.5 wt. % to about 50 wt. %, and typically about 1 wt. % to about 20 wt. %.

One non-limiting object of the present invention is the provision of an improved evaporation barrier that incorporates multifunctional particles to reduce evaporation of liquid form a pond or reservoir.

Another and/or alternative non-limiting object of the present invention is the provision of an evaporation barrier that includes a water-insoluble liquid, an impermeable solid, optionally a hydrophobic compound, and optionally a coupling agent.

Another and/or alternative non-limiting object of the present invention is the provision of an evaporation barrier wherein the water-insoluble liquid include an alkane, non-volatile oil, and/or non-volatile silicone oil.

Another and/or alternative non-limiting object of the present invention is the provision of an evaporation barrier wherein the water-insoluble liquid has a density that is less than water, or less than saltwater or less than brine, or fracking fluid so that the water-insoluble liquid floats on the top surface of the water, saltwater, brine, or fracking fluid.

Another and/or alternative non-limiting object of the present invention is the provision of an evaporation barrier wherein the water-insoluble liquid includes a mixture of one or more alkanes and one or more non-volatile oils.

Another and/or alternative non-limiting object of the present invention is the provision of an evaporation barrier wherein the water-insoluble liquid has a vapor pressure of less than 0.1 torr at 80° C.

Another and/or alternative non-limiting object of the present invention is the provision of an evaporation barrier wherein the impermeable solid can be or include a reflective material and/or a non-reflective material.

Another and/or alternative non-limiting object of the present invention is the provision of an evaporation barrier wherein the impermeable solid includes a reflective material such as aluminum, aluminum alloy, magnesium, and/or magnesium alloy in powder and/or flake form, and/or reflective microballoons and/or microballs (e.g., aluminum-coated 3M Scotchlight™ glass microballoons).

Another and/or alternative non-limiting object of the present invention is the provision of an evaporation barrier wherein the impermeable solid includes a reflective material having a reflectance of at least 75% and up to 99.99% (and all values and ranges therebetween) in the visible light spectrum, and a reflectance of at least 50% and up to 99.99% (and all values and ranges therebetween) in the long IR wavelength spectrum.

Another and/or alternative non-limiting object of the present invention is the provision of an evaporation barrier wherein the impermeable solid includes a reflective material having a reflectance of at least 80% in the visible light spectrum, and a reflectance of at least 50% in the long IR wavelength spectrum.

Another and/or alternative non-limiting object of the present invention is the provision of an evaporation barrier wherein the impermeable solid includes a reflective material having a reflectance of at least 85% in the visible light spectrum, and a reflectance of at least 50% in the long IR wavelength spectrum.

Another and/or alternative non-limiting object of the present invention is the provision of an evaporation barrier wherein the impermeable solid includes a reflective material having a reflectance of at least 90% in the visible light spectrum, and a reflectance of at least 50% in the long IR wavelength spectrum.

Another and/or alternative non-limiting object of the present invention is the provision of an evaporation barrier wherein the impermeable solid includes a non-reflective material such as an optically transparent or translucent material (e.g., glass or polymeric flakes, glass, ceramic, or polymeric microballoons and/or microballs, silica, mica, or other translucent or transparent particle).

Another and/or alternative non-limiting object of the present invention is the provision of an evaporation barrier wherein the impermeable solid is surface treated to make the surface of the impermeable solid hydrophobic and/or oil-philic (e.g., lipophilic) so that impermeable solid remains in the liquid phase (e.g., water-insoluble liquid).

Another and/or alternative non-limiting object of the present invention is the provision of an evaporation barrier wherein the hydrophobic compound (when used) is a hydrophobic constituent and/or surfactant that can be used to facilitate in the dispersion of the improved evaporation barrier of the present invention, the coating thickness of the present invention, and/or the stability improved evaporation barrier of the present invention when dispersed on the surface of the water, saltwater, brine, or fracking liquid.

Another and/or alternative non-limiting object of the present invention is the provision of an evaporation barrier having one or more of the following properties: 1) does not interfere with the chemistry of the aqueous phase (e.g., the water, saltwater, brine, fracking fluid); 2) has a boiling point above 150° C., and typically above 200° C.; and/or 3) has a low viscosity (less than 1000 mPa-s at room temperature (e.g., 77° F.) in accordance with ASTM D7042-04).

Another and/or alternative non-limiting object of the present invention is the provision of an evaporation barrier wherein the viscosity is 20-400 mPa-s (and all values and ranges therebetween).

Another and/or alternative non-limiting object of the present invention is the provision of an evaporation barrier wherein the water-insoluble liquid includes one or more alkanes that have a density that is less than water, saltwater, brine, or fracking fluid.

Another and/or alternative non-limiting object of the present invention is the provision of an evaporation barrier wherein the water-insoluble liquid includes one or more alkanes that have a density of 0.73 to 0.86 (and all values and ranges therebetween) as determined by ASTM D5002-94.

Another and/or alternative non-limiting object of the present invention is the provision of an evaporation barrier wherein the water-insoluble liquid includes one or more alkanes that have a low viscosity (less than 1000 mPa-s at room temperature) and/or a low vapor pressure (less than 5 mmHg at room temperature).

Another and/or alternative non-limiting object of the present invention is the provision of an evaporation barrier wherein the water-insoluble liquid includes one or more alkanes that have a viscosity of 20-400 mPa-s.

Another and/or alternative non-limiting object of the present invention is the provision of an evaporation barrier wherein the water-insoluble liquid includes one or more alkanes, and one or more non-volatile oils.

Another and/or alternative non-limiting object of the present invention is the provision of an evaporation barrier wherein the one or more non-volatile oils include silicone oil, vegetable oil, and/or mineral oil or paraffin oils.

Another and/or alternative non-limiting object of the present invention is the provision of an evaporation barrier that includes reflective material to create an added physical barrier to evaporation, and/or to reflect solar radiation to inhibit and/or prevent heating of the water, saltwater, brine, or fracking fluid.

Another and/or alternative non-limiting object of the present invention is the provision of an evaporation barrier that can include a reflective material and no non-reflective material, a non-reflective material and no reflective material, or can include both a reflective and non-reflective material.

Another and/or alternative non-limiting object of the present invention is the provision of an evaporation barrier wherein the reflective material includes a) aluminum, aluminum alloy, magnesium and/or magnesium alloy powder having an average particle size of generally 0.01-200 microns, b) aluminum, aluminum alloy, magnesium and/or magnesium alloy flakes having an average size of 1 micron or less in average thickness by about 60-200 (and all values and ranges therebetween) microns in average diameter, c) microballs or microballoons (e.g., aluminum-coated 3M Scotchlight™ glass microballoons, etc.), and/or d) materials coated with and engineered pigments (e.g., glass or ceramic or plastic balls or flakes that are coated pigments such as TiO₂, ZrO₂, etc.).

Another and/or alternative non-limiting object of the present invention is the provision of an evaporation barrier that includes a non-reflective material to create an added physical barrier to evaporation, and/or to inhibit or prevent heating of the water, saltwater, brine, or fracking fluid.

Another and/or alternative non-limiting object of the present invention is the provision of an evaporation barrier that includes a non-reflective material such as an optically transparent or translucent material such as glass or polymeric flakes, glass, ceramic, or polymeric microballoons and/or microballs, silica, mica, or other translucent or transparent particle.

Another and/or alternative non-limiting object of the present invention is the provision of an evaporation barrier that includes a non-reflective material having a density that can be greater than, equal to, or less than the density of water (i.e., 1 g/cc).

Another and/or alternative non-limiting object of the present invention is the provision of an evaporation barrier that includes a non-reflective material having a size of 0.01-200 microns.

Another and/or alternative non-limiting object of the present invention is the provision of an evaporation barrier that includes a non-reflective material has at least 30% transmittance (e.g., at least 30% of the electromagnetic radiation passes through the through the material) and up to 99.99% transmittance.

Another and/or alternative non-limiting object of the present invention is the provision of an evaporation barrier that includes both reflective material and non-reflective material.

Another and/or alternative non-limiting object of the present invention is the provision of an evaporation barrier that includes both reflective material and non-reflective material and wherein the weight ratio of reflective material to non-reflective material is 0.01-100:1 (and all values and ranges therebetween).

Another and/or alternative non-limiting object of the present invention is the provision of an evaporation barrier that includes both reflective material and non-reflective material and wherein the weight percent of reflective material is greater than the weight percent of non-reflective material.

Another and/or alternative non-limiting object of the present invention is the provision of an evaporation barrier that includes both reflective material and non-reflective material and wherein the weight ratio of reflective material to non-reflective material is 1.01-100:1 (and all values and ranges therebetween).

Another and/or alternative non-limiting object of the present invention is the provision of an evaporation barrier that includes a coupling agent.

Another and/or alternative non-limiting object of the present invention is the provision of an evaporation barrier that includes a coupling agent that is a lipophilic and/or hydrophobic coupling agent.

Another and/or alternative non-limiting object of the present invention is the provision of an evaporation barrier that includes a coupling agent that is used to wet the reflective material and/or the non-reflective material so as to facilitate in maintaining suspension of the reflective material and/or the non-reflective material in the hydrocarbon phase (e.g., water-insoluble liquid) of the evaporation barrier before and after the evaporation barrier is dispersed into an aqueous phase (e.g., water, saltwater, brine, fracking fluid).

Another and/or alternative non-limiting object of the present invention is the provision of an evaporation barrier that includes a coupling agent that includes a silane compound.

Another and/or alternative non-limiting object of the present invention is the provision of an evaporation barrier that includes a coupling agent that is coated on the reflective material and/or the non-reflective material such that the coupling agent constitutes 0.1-3 wt. % of the coated reflective material and/or the non-reflective material (and all values and ranges therebetween).

Another and/or alternative non-limiting object of the present invention is the provision of an evaporation barrier that includes a coupling agent that is coated on the reflective material and/or the non-reflective material such that the coating thickness of the coupling agent is about 10-500 nm (and all values and ranges therebetween).

Another and/or alternative non-limiting object of the present invention is the provision of an evaporation barrier that includes a coupling agent that is coated on the reflective material and/or the non-reflective material wherein the reflective material and/or the non-reflective material has a density greater than the hydrocarbon phase of the evaporation barrier and the coupling agent that is coated on the reflective material and/or the non-reflective material is able to maintain the reflective material and/or the non-reflective material suspended in the evaporation barrier for at least 1-7 days (and all values and ranges therebetween).

Another and/or alternative non-limiting object of the present invention is the provision of an evaporation barrier that includes a coupling agent that is coated on the reflective material and/or the non-reflective material wherein the reflective material and/or the non-reflective material has a density greater than the hydrocarbon phase of the evaporation barrier and/or the aqueous phase (e.g., water, saltwater, brine, fracking fluid) into which the evaporation barrier is dispersed and the coupling agent that is coated on the reflective material and/or the non-reflective material is able to maintain the reflective material and/or the non-reflective material suspended in the evaporation barrier for at least 1-7 days (and all values and ranges therebetween) before and after the evaporation barrier is dispersed into the aqueous phase.

Another and/or alternative non-limiting object of the present invention is the provision of an evaporation barrier that includes a hydrophobic compound.

Another and/or alternative non-limiting object of the present invention is the provision of an evaporation barrier that includes a hydrophobic compound in the form of a surfactant, wetting agent, detergent, solubilizes, and/or soap.

Another and/or alternative non-limiting object of the present invention is the provision of an evaporation barrier that includes a hydrophobic compound in the form of a surfactant that has a HLB value of 5 and 15 (and all values and ranges therebetween).

Another and/or alternative non-limiting object of the present invention is the provision of an evaporation barrier that includes a hydrophobic compound in the form of a surfactant that includes polyoxyethylene sorbitans, polyoxyethylene ethers, BRIJ (e.g., polyoxyethylene 10 oleyl ether (sold under the tradename BRIJ™ 96, CAS#9004-98-2, Sigma Chemical Company, St. Louis, Mo.).

Another and/or alternative non-limiting object of the present invention is the provision of an evaporation barrier wherein the evaporation barrier can be prepared first by providing the water-insoluble liquid (e.g., alkane and optional non-volatile oil [e.g., non-volatile oil, wax and non-volatile oil]) and optional surfactant that is mixed with the water-insoluble liquid, and the water-insoluble liquid is thereafter mixed with the reflective material and/or non-reflective material.

Another and/or alternative non-limiting object of the present invention is the provision of an evaporation barrier wherein the reflective material and/or non-reflective material is added in a quantity such that the overall density of the evaporation barrier of the present invention remains below the density of the aqueous phase (e.g., water, saltwater, brine, fracking fluid), such that upon dispersion into the aqueous phase, the evaporation barrier separates and floats to the surface of the aqueous phase.

Another and/or alternative non-limiting object of the present invention is the provision of an evaporation barrier wherein the evaporation barrier can be stored at room temperature (e.g., 77° F.) in a container (e.g., a clear or opaque glass bottle or container, plastic bottle or container, drum, etc.).

Another and/or alternative non-limiting object of the present invention is the provision of an evaporation barrier wherein the evaporation barrier is dispensed in a sufficient amount to cover the aqueous phase (e.g., water, saltwater, brine, fracking fluid) that is located in a pond, tank, retention pond, reservoir, basin, lake, open retention container, storage container, etc.

Another and/or alternative non-limiting object of the present invention is the provision of an evaporation barrier wherein the evaporation barrier is dispensed in a sufficient amount to cover the aqueous phase such that the thickness of the evaporation barrier on the surface of the aqueous phase is at least about 0.05 microns.

Another and/or alternative non-limiting object of the present invention is the provision of an evaporation barrier wherein the evaporation barrier is dispensed in the aqueous phase by dumping a bucket or barrel of evaporation barrier into the aqueous phase, or pumping the evaporation barrier onto or into a pond, tank, retention pond, reservoir, basin, lake, open retention container, storage container, etc. that contains the aqueous phase.

Another and/or alternative non-limiting object of the present invention is the provision that additional aqueous phase can be added to an aqueous phase that is covered with the evaporation barrier without damaging or impairing the effectiveness of the evaporation barrier.

Another and/or alternative non-limiting object of the present invention is the provision of an evaporation barrier wherein the evaporation barrier is added to the aqueous phase in a sufficient amount to cover the surface of the aqueous phase.

Another and/or alternative non-limiting object of the present invention is the provision of an evaporation barrier wherein the evaporation barrier is added to the aqueous phase to form a continuous film on the surface of the aqueous phase that has a thickness of about 0.05-5,000 microns (and all values and ranges therebetween).

Another and/or alternative non-limiting object of the present invention is the provision of an evaporation barrier wherein the impermeable solid is present in the improved evaporation barrier in sufficient concentration to cover at least 30% (e.g., 30-100% and all values and ranges therebetween) of the top surface area an aqueous phase when the improved evaporation barrier is added to the aqueous phase, and typically at least 60% of the top surface area an aqueous phase when the improved evaporation barrier is added to the aqueous phase, more typically at least 80% of the top surface area an aqueous phase when the improved evaporation barrier is added to the aqueous phase, and still more typically at least 95% of the top surface area an aqueous phase when the improved evaporation barrier is added to the aqueous phase.

Another and/or alternative non-limiting object of the present invention is the provision of an evaporation barrier wherein the impermeable solid can be arranged in a monolayer or multilayer fashion on or at the surface of the aqueous phase when the improved evaporation barrier is added to the aqueous phase.

Another and/or alternative non-limiting object of the present invention is the provision of an evaporation barrier wherein the film on the surface of the aqueous phase that is formed by the improved evaporation barrier is formulated to block at least 60% of water evaporation from the aqueous phase in a pond, lake, reservoir, retention tank, etc. at a temperature up to about 85° C. where the film remains intact on the surface of the aqueous phase, and typically at least 70% of water evaporation from the aqueous phase in a pond, lake, reservoir, retention tank, etc. at a temperature up to about 85° C. where the film remains intact on the surface of the aqueous phase.

Another and/or alternative non-limiting object of the present invention is the provision of an evaporation barrier wherein the film on the surface of the aqueous phase that is formed by the improved evaporation barrier is formulated to allow for the passage of trapped gasses and bubbles (which pass through the film as gas bubbles due to the density of the gas and film) to pass upwardly through the film.

Another and/or alternative non-limiting object of the present invention is the provision of an evaporation barrier wherein the film is formulated to allow for the passage of water droplets or puddles (such as water from rain or water from a hose) to pass downwardly through the film into the aqueous phase in a pond, lake, reservoir, retention tank, etc.

Another and/or alternative non-limiting object of the present invention is the provision of an evaporation barrier that can be easily floated over the aqueous phase by simply dumping a bucket or barrel, or pumping the liquid improved evaporation barrier onto or into a pond, basin or above-ground storage container that contains the aqueous phase.

Another and/or alternative non-limiting object of the present invention is the provision of an evaporation barrier wherein additional aqueous phase (e.g., water, saltwater, brine, fracking liquid, etc.) can be added in any manner (such as rain, pipe outflow, etc.) to the pond, basin or above-ground storage container that already contains the improved evaporation barrier without damaging or impairing the effectiveness of the improved evaporation barrier on the surface of the aqueous phase.

Another and/or alternative non-limiting object of the present invention is the provision of an evaporation barrier comprising a) a water-insoluble liquid having a density of less than 1 g/cc and viscosity of less than 400 cP at 25° C.; and b) an impermeable solid material at a concentration of 0.5-25 vol. %; wherein the evaporation barrier has a density of less than 1.4 g/cc, typically less than 1.2 g/cc, more typically less than 1 g/cc, and even more typically less than 0.7 g/cc; and wherein at least 20% of the impermeable solid material is at least partially retained in the water-insoluble liquid, typically at least 40% of the impermeable solid material is at least partially retained in the water-insoluble liquid, more typically at least 50% of the impermeable solid material is at least partially retained in the water-insoluble liquid, still more typically at least 60% of the impermeable solid material is at least partially retained in the water-insoluble liquid, and even more typically at least 75% of the impermeable solid material is at least partially retained in the water-insoluble liquid when the evaporation barrier is added to an aqueous phase.

Another and/or alternative non-limiting object of the present invention is the provision of an evaporation barrier wherein the reflective material is selected from aluminum, magnesium, and their alloys, or a metallized particle or reflective pigment, any microballoon and/or microball with a reflectance of at least 50% in the visible and at least 30% in the long IR wavelengths, and typically at least 75% in the visible and at least 50% in the long IR wavelengths.

Another and/or alternative non-limiting object of the present invention is the provision of an evaporation barrier wherein the reflective material is or includes aluminum particles, aluminum flakes, aluminum alloy particles, aluminum alloy flakes, magnesium particles, magnesium flakes, magnesium alloy particles, magnesium alloy flakes that are degradable upon extended reaction with water or saltwater, and wherein the degradable materials optionally degrade by at least 10% of their original weight within 360 days upon exposure to water, saltwater or brine at a temperature of at least 90° F.

Another and/or alternative non-limiting object of the present invention is the provision of an evaporation barrier wherein the non-reflective material is selected from an optically transparent or translucent material such as glass or polymeric flakes, glass, ceramic, or polymeric microballoons and/or microballs, silica, mica, or other translucent or transparent particle, and has transmittance of at least 30%.

Another and/or alternative non-limiting object of the present invention is the provision of an evaporation barrier wherein the reflective and/or non-reflective material can at least partially react to produce bubbles on its surface to create additional buoyancy, wherein such bubbles can reduce density and/or add buoyancy to the reflective and/or non-reflective material by the gas generated to facilitate in keeping the reflective and/or non-reflective material buoyant for longer periods of time.

Another and/or alternative non-limiting object of the present invention is the provision of an evaporation barrier wherein the reflective and/or non-reflective material is treated with a hydrophobic or lipophillic surface treatment.

Another and/or alternative non-limiting object of the present invention is the provision of an evaporation barrier wherein the surface treatment is using coupling agents such as, but not limited to, silane.

Another and/or alternative non-limiting object of the present invention is the provision of an evaporation barrier that includes surfactant.

Another and/or alternative non-limiting object of the present invention is the provision of an evaporation barrier that includes antimicrobial particles or antimicrobial medium soluble in the oil or hydrocarbon, or non-aqueous mixture.

Another and/or alternative non-limiting object of the present invention is the provision of an evaporation barrier wherein the oil or hydrocarbon, or non-aqueous mixture can be any oil, such as vegetable oil, silicone oil, vegetable oil, mineral oil.

Another and/or alternative non-limiting object of the present invention is the provision of an evaporation barrier wherein a thickness of the improved evaporation barrier on the surface of the aqueous phase is about 0.1 micron to 2 mm.

Another and/or alternative non-limiting object of the present invention is the provision of an evaporation barrier that is prepared by any mixing method, such as shear mixing, vortex mixing, ultrasound mixing, or other high intensity mixing method designed to shear mechanical and/or physicochemical agglomerates to create a stable dispersion.

Another and/or alternative non-limiting object of the present invention is the provision of an evaporation barrier comprising a) a water-insoluble liquid having a density less than 1 g/cc; and, b) an impermeable solid material, the impermeable solid material, the impermeable solid material is a flake, particle, microballoon, and/or microball, and wherein at least 20% of the impermeable solid material remains suspended in the water-insoluble liquid for at least 1 day after being mixed with the water-insoluble liquid, typically at least 25% of the impermeable solid material remains suspended in the water-insoluble liquid for at least 1 day after being mixed with the water-insoluble liquid, more typically at least 40% of the impermeable solid material remains suspended in the water-insoluble liquid for at least 1 day after being mixed with the water-insoluble liquid, still more typically at least 50% of the impermeable solid material remains suspended in the water-insoluble liquid for at least 1 day after being mixed with the water-insoluble liquid, and even more typically at least 55% of the impermeable solid material remains suspended in the water-insoluble liquid for at least 1 day after being mixed with the water-insoluble liquid.

Another and/or alternative non-limiting object of the present invention is the provision of an evaporation barrier wherein the impermeable solid material includes materials that have a reflectiveness of at least 50% in UV and/or IR ranges, and typically at least 70% in UV and/or IR ranges.

Another and/or alternative non-limiting object of the present invention is the provision of an evaporation barrier wherein the impermeable solid material includes materials that have a transmittance of greater than 40%, and typically greater than 65% transmittance in the optical wavelengths.

Another and/or alternative non-limiting object of the present invention is the provision of an evaporation barrier wherein the impermeable solid material is selected from an optically transparent or translucent material such as glass or polymeric flakes, glass, ceramic, or polymeric microballoons and/or microballs, silica, mica, or other translucent or transparent particle.

Another and/or alternative non-limiting object of the present invention is the provision of an evaporation barrier wherein the impermeable solid material is selected from one or more materials selected from group of mica flakes, glass flakes, glass microspheres, ceramic microspheres, polymer flakes, polymer microspheres, calcite, gypsum/selenite, lucite, magnesium carbonate, zeolite, montmotillionite, kaolin, feldspar, polypropylene, polyacytal, acrylic, or other inorganic or organic particles.

Another and/or alternative non-limiting object of the present invention is the provision of an evaporation barrier wherein the impermeable solid material includes one or more materials having a density of greater than 1 g/cc.

Another and/or alternative non-limiting object of the present invention is the provision of an evaporation barrier wherein the impermeable solid material includes one or more materials having a density of no greater than 3 g/cc.

Another and/or alternative non-limiting object of the present invention is the provision of an evaporation barrier wherein the impermeable solid material includes one or more materials having a density of less than 1 g/cc.

Another and/or alternative non-limiting object of the present invention is the provision of an evaporation barrier wherein the water-insoluble liquid has a vapor pressure of less than 0.1 torr at 80° C.

Another and/or alternative non-limiting object of the present invention is the provision of an evaporation barrier wherein the water-insoluble liquid has a solubility in water that is less than 1000 ppm solubility.

Another and/or alternative non-limiting object of the present invention is the provision of an evaporation barrier wherein the water-insoluble liquid has a solubility in water such that a water content in the water-insoluble liquid at a temperature of about 25° C. to 80° C. is less than 5 vol. %.

Another and/or alternative non-limiting object of the present invention is the provision of an evaporation barrier wherein the water-insoluble liquid includes one or more components selected form the group of hydrocarbons (e.g., alkanes, from C₈-C₃₀, including paraffin oils, mineral oils, kerosene-based fuel (e.g., JP8 (MIL-DTL-83133)), fuel oil, heating oil, vegetable oil such as soybean oil, linseed oil, canola oil, or other vegetable oil, etc.), silicones, silicon oil, mineral oil, and other insoluble, low vapor pressure oils, as well as mixtures of these oils.

Another and/or alternative non-limiting object of the present invention is the provision of an evaporation barrier wherein the water-insoluble liquid has a viscosity of less than about 10,000 cP at 25° C.

Another and/or alternative non-limiting object of the present invention is the provision of an evaporation barrier wherein the impermeable solid material is treated with a hydrophobic or lipophillic surface treatment.

Another and/or alternative non-limiting object of the present invention is the provision of an evaporation barrier wherein the surface treatment is using coupling agents such as, but not limited to, silane, silicone, siloxane, and/or silizane.

Another and/or alternative non-limiting object of the present invention is the provision of an evaporation barrier wherein the surfactant includes one or more components selected from linear alkylbenzenesulfonates, lignin sulfonates, fatty alcohol ethoxylates, alkylphenol ethoxylates, ammonium lauryl sulfate, sodium lauryl sulfate, dioctyl sodium sulfosuccinate (DOSS), sorbitan monooleate (Span 80), and polyoxyethylenated sorbitan monooleate, among others.

Another and/or alternative non-limiting object of the present invention is the provision of an evaporation barrier that includes antimicrobial particles or antimicrobial medium soluble in said oil or hydrocarbon, or non-aqueous mixture.

Another and/or alternative non-limiting object of the present invention is the provision of an evaporation barrier wherein the impermeable solid is present in a sufficient concentration to cover at least 30% of the surface area an aqueous phase when the impermeable solid and water-insoluble liquid mixture is added to the aqueous phase.

Another and/or alternative non-limiting object of the present invention is the provision of an evaporation barrier wherein the reflectivity of the evaporation barrier is obtained through phase separation of different refractive index liquid phases, or other inhomogeneous mixture to create the reflectivity.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates a dispersion of glass flakes as the impermeable solid in a water-insoluble liquid, wherein glass flakes cover approximately 80% of the total surface area of the aqueous phase.

FIG. 2 illustrates a multilayered flake evaporation resistant coating with overlap of the flakes.

FIG. 3 illustrates an improved evaporation barrier incorporating glass microballoons as the impermeable solid, which cover approximately 50% of the surface area of the aqueous phase.

### DESCRIPTION OF THE INVENTION

The improved evaporation barrier of the present invention incorporates multifunctional particles to reduce evaporation of liquid form a pond or reservoir. The improved evaporation barrier of the present invention is typically in liquid form. The improved evaporation barrier of the present invention includes:

1. Water-Insoluble Liquid.

The water-insoluble liquid can include an alkane, non-volatile oil, and/or non-volatile silicone oil. The water-insoluble liquid generally has a density that is less than water (i.e., less than 1 g/cc), saltwater, brine, or fracking fluid so that the water-insoluble liquid floats on the top surface of the water, saltwater, brine or fracking fluid. Generally, the water-insoluble liquid includes a mixture of one or more alkanes and one or more non-volatile oils. The water-insoluble liquid typically has a vapor pressure of less than 0.1 torr at 80° C. Generally, the water-insoluble liquid is insoluble in water. Generally, the solubility of the water-insoluble liquid in water is less than 1000 ppm solubility in water, typically less than 100 ppm solubility in water, more typically no more than 10 ppm solubility in water, and even more typically no more than 1 ppm solubility in water. The water-insoluble liquid generally is formulated so as to not react with water. In one non-limiting embodiment, the water-insoluble liquid has a solubility such that the water content in the water-insoluble liquid at a temperature of about 25-80° C. is less than 5 vol. %, and typically less than 1 vol. %.

Non-limiting examples of water-insoluble liquid include hydrocarbons (e.g., alkanes, from C₈-C₃₀, including paraffin oils, mineral oils, JP8, fuel oil, heating oil, vegetable oils such as soybean oil, linseed oil, canola oil, or other vegetable oil, etc.), silicones and other insoluble, low vapor pressure oils, as well as mixtures of these oils. In one non-limiting embodiment, the water-insoluble liquid is or includes a low density vegetable oil that is mixed with a paraffin oil to reduce density of the mixture. A low viscosity PDMS (silicone oil) can also be added to the vegetable oil and paraffin oil mixture to form an easily spreadable, low viscosity water-insoluble liquid for mixing with the impermeable solid. The water-insoluble liquid has a viscosity of about 1-10,000 cP at 25° C. (and all values and ranges therebetween) (ASTM D7042-04), and generally from 5-500 cP at 25° C. The water-insoluble liquid should be viscous enough to easily retain the impermeable solid and to not be easily dispersed or atomized when added into a liquid such as water in a pond, reservoir, etc., but also not be so viscous as to prevent the impermeable solid from easily and quickly spreading on the surface of an aqueous phase (e.g., water, saltwater, brine, fracking fluid that is in a pond, reservoir, etc.).

The volume percent of the water-insoluble liquid in the evaporation barrier is generally 60-99.5 vol. % (and all values and ranges therebetween). When the water-insoluble liquid includes both alkane and non-volatile oil, the volume percent of the alkane content is generally at least 50 wt. % of the water-insoluble liquid, and typically greater than 50 wt. % of the water-insoluble liquid; however, this is not required. In one non-limiting embodiment, the volume ratio of the alkane to the non-volatile oil in the water-insoluble liquid is 1-100:1 (and all values and ranges therebetween), typically 1-25:1, more typically 1.01-10:1, and still more typically 1.1-5:1.

2. Impermeable Solid.

The impermeable solid can be or include a reflective material and/or a non-reflective material (e.g., mica flakes, glass flakes, glass microspheres, ceramic microspheres, polymer flakes, polymer microspheres, calcite, gypsum/selenite, lucite, magnesium carbonate, zeolite, montmotillionite, kaolin, feldspar, polypropylene, polyacytal, acrylic, or other inorganic or organic particles).

Generally, the impermeable solid is an inorganic material; however, this is not required. In one non-limiting embodiment, 75-100% (and all values and ranges therebetween) of the impermeable solid is an inorganic material. The impermeable solid is generally in flake, platelet, or spherical form; however, other shapes can be used.

The impermeable solid generally has a density of less than about 3 g/cc (e.g., 2.99 g/cc to 0.1 g/cc and all values and ranges therebetween); however, this is not required. In one non-limiting embodiment, the impermeable solid generally has a density of less than about 2.5 g/cc. The impermeable solid may be hollow (e.g., glass microballoon and/or microball, ceramic microballoon and/or microball, polymer microballoon and/or microball, metal microballoons and/or microball, etc.) to reduce its effective density and provide buoyancy; however, this is not required. The impermeable solid may be include flake materials (e.g., glass flakes, mica flakes, polymer flakes, ceramic flakes, metal flakes, etc.).

The impermeable solid, and the resulting impermeable solid dispersion in the water-insoluble liquid, may optionally be transparent, translucent, or have a predetermined color, such as through the use of colored pigments or colored flakes. The degree of reflectivity of the improved evaporation barrier can be fine-tuned by the use of colored impermeable solid, and/or the use of different colored impermeable solid. For example, use of certain colored impermeable solid and/or the use of a certain amount of colored and/or non-colored impermeable solid can optionally be used to reflect certain light bandwidths to control the transmission/reflection of certain light bandwidths on the improved evaporation barrier. In addition or alternatively, the use of certain colored impermeable solid and/or the use of a certain amount of colored and/or non-colored impermeable solid can optionally be used to create a certain color on the top surface of the improved evaporation barrier which can be used as color coding for a certain pond, lake, reservoir, retention tank, etc. Such color coding can be used to identify certain ponds, lakes, reservoirs, retention tanks, etc., identify the contents of certain ponds, lakes, reservoirs, retention tanks, etc., and/or to distinguish different ponds, lakes, reservoirs, retention tanks, etc. from other ponds, lakes, reservoirs, retention tanks, etc.

The impermeable solid, when a reflective material, can be a material such as an aluminum, aluminum alloy, magnesium, and/or magnesium alloy in powder and/or flake form. Other or additional materials such as, but not limited to, microballoons and/or microballs (e.g., aluminum-coated 3M Scotchlight™ glass microballoons) can be used. The reflectivity or reflectance of the surface of the reflective material is its effectiveness in reflecting radiant energy. High reflection is defined as a reflectance of at least 75% in the visible (ASTM E903-96 and ASTM E903-88), and 50% in the long IR wavelengths (ASTM E408-71). Other separate phases with reflective properties can also be envisioned, such as phase-separating liquid phase with a high difference in refractive index to cause reflection. Other possible approaches are obtaining near perfect reflection at the water-hydrocarbon interface through control over refractive index. Reflection can be either specular or diffuse, with specular being a preferred solution, with diffuse being acceptable as long as greater than about 90% of the light is prevented from reaching more than a millimeter or two into the aqueous phase.

The impermeable solid, when a non-reflective material, can be a material such as an optically transparent or translucent material such as glass or polymeric flakes, glass, ceramic, or polymeric microballoons and/or microballs, silica, mica, or other translucent or transparent particle.

The impermeable solid can optionally be surface treated to make the surface of the particle or flake hydrophobic and/or oil-philic (e.g., lipophilic) so that the impermeable solid remains in the liquid phase (e.g., water-insoluble liquid) of the improved evaporation barrier of the present invention.

The aspect ratio of the impermeable solid can optionally be selected to improve the improved evaporation barrier. In one non-limiting embodiment, an impermeable solid having a higher aspect ratio (e.g., greater than 10) can be included in the improved evaporation barrier to 1) benefit the stability of the solid dispersion in the improved evaporation barrier, and/or 2) improve water conservation performance of the improved evaporation barrier by allowing less solids loading.

The volume percent of the impermeable solid in the evaporation barrier is about 0.5-40% (and all values and ranges therebetween). When the evaporation barrier includes both reflective material and non-reflective material, the reflective material generally constitutes 1-99 wt. % of the impermeable solid (and all values and ranges therebetween). In one non-limiting embodiment, the reflective material constitutes 5-99 wt. % of the impermeable solid with the balance of the impermeable solid constituting non-reflective material. In another non-limiting embodiment, the reflective material constitutes 25-99 wt. % of the impermeable solid with the balance of the impermeable solid constituting non-reflective material. In another non-limiting embodiment, the reflective material constitutes 40-99 wt. % of the impermeable solid with the balance of the impermeable solid constituting non-reflective material. In another non-limiting embodiment, the reflective material constitutes 50-99 wt. % of the impermeable solid with the balance of the impermeable solid constituting non-reflective material. In another non-limiting embodiment, the reflective material constitutes 50.1-99 wt. % of the impermeable solid with the balance of the impermeable solid constituting non-reflective material. In another non-limiting embodiment, the reflective material constitutes 55-99 wt. % of the impermeable solid with the balance of the impermeable solid constituting non-reflective material.

3. Coupling Agent.

A coupling agent (when used) can be used to enable or facilitate the retention of the impermeable solid by surface tension in the water-insoluble liquid. The coupling agent is generally formulated to produce a hydrophobic or organophilic surface on the impermeable solid so as to retain the impermeable solid in the water-insoluble liquid. Generally the coupling agent is coated on the impermeable solid. Non-limiting examples of coupling agents are silane, silicone, siloxane, silizane. However, it can be appreciated that the coupling agent can be any surface treatment and/or impermeable solid surface chemistry capable of creating a highly wetted surface (e.g., contact angel of less than 90° degrees and typically less than 30°) in the water-insoluble liquid. In one non-limiting embodiment, the coupling agent forms a hydrophobic surface on the impermeable solid where its contact angle with the aqueous phase (e.g., the water, saltwater, brine, fracking fluid) is greater than about 90° degrees, and typically greater than about 120°. The surface functionalization of the impermeable solid (when used) typically results in a resultant surface with a surface energy of about 20-35 dynes/cm² (and all values and ranges therebetween) (ASTM D2578). Non-limiting examples of coupling agents include ethyltrimethoxysilane, octadecyltrichlorosilane, methyltrimethoxysilane, nonafluorohexyltrimethoxysilane, vinyltriethoxysilane, propyltrimethoxysilane, trifluoropropyltrimethoxysilane, 3-(2-aminoethyl)-aminopropyltrimethoxysilane, p-tolyltrimethoxysilane, cyanoethyltrimethoxysilane, aminopropyltriethoxysilane, and acetoxypropyltrimethoxylsilane. The volume percent of the coupling agent in the evaporation barrier is about 0-4% (and all values and ranges therebetween). The coupling agent generally constitutes about 0.1-3 wt. % (and all values and ranges therebetween) of the coated particle (i.e., the impermeable solid that is coated with the coupling agent).

4. Hydrophobic Compound.

The hydrophobic compound (when used) can be a hydrophobic constituent and/or surfactant that can be used to facilitate in the dispersion of the improved evaporation barrier of the present invention, the coating thickness of the present invention, and/or the stability improved evaporation barrier of the present invention when dispersed on the surface of the aqueous phase (e.g., water, saltwater, brine, fracking liquid, etc.). The hydrophobic compound is an optional component of the improved evaporation barrier of the present invention. One non-limiting hydrophobic compound that can be used includes surfactant; however, other or additional types of hydrophobic compound can be used (e.g., wetting agents, detergents, solubilizers, soaps, etc.). A surfactant, such as a non-ionic surfactant, (when used) can be added to the water-insoluble liquid to aid in the spreading of the improved evaporation barrier on the surface of the aqueous phase (e.g., water, saltwater, brine, fracking fluid), and/or to inhibit or prevent the “breaking” of the improved evaporation barrier on the surface of the aqueous phase. Non-limiting surfactants include linear alkylbenzenesulfonates, lignin sulfonates, fatty alcohol ethoxylates, alkylphenol ethoxylates, ammonium lauryl sulfate, sodium lauryl sulfate, dioctyl sodium sulfosuccinate (DOSS), sorbitan monooleate (Span 80), and polyoxyethylenated sorbitan monooleate, among others. The volume percent of the hydrophobic compound in the evaporation barrier is about 0-4% (and all values and ranges therebetween).

The improved evaporation barrier of the present invention has one or more of the following properties:

A. The improved evaporation barrier does not interfere with the chemistry of the aqueous phase (e.g., water, or saltwater, brine, fracking fluid);

B. The improved evaporation barrier has a boiling point above 150° C., and typically above 200° C.; and/or

C. The improved evaporation barrier has a low viscosity. Low viscosity is defined as less than 1000 mPa-s at room temperature (e.g., 77° F.). Typically, the viscosity of the evaporation barrier is between 20-400 mPa-s (and all values and ranges therebetween). The characterization method for the viscosity is performed by Stabinger Viscometer (ASTM D7042-04).

Alkane

As used herein, the term “alkane” refers to a class of aliphatic hydrocarbons characterized by a straight chain (having a generic formula Cₙ H₂ₙ₊₂, an n-paraffinic hydrocarbon) or branched-chain or cyclic carbon chain each having from 1 to greater than 50 carbons that can be used as the water-insoluble liquid. Alkanes which are useful in the improved evaporation barrier of the present invention have at least about 6 carbons. One non-limiting type of alkane that can be used in the improved evaporation barrier of the present invention is straight-chain alkanes that include the C₆ to C₁₇ hydrocarbons (commonly referred to as mineral oils) and the C₁₈ to C₂₀ hydrocarbons (commonly referred to as waxes) which are solid at room temperature. Non-limiting examples of such alkanes are medium-chain alkanes having from 10 (decane) to 20 (icosane) carbons, and a wax octadecane (C₁₈). Alkanes can have more than 20 carbons when the alkane is branched or cyclic. Mixtures of alkanes also can be used. Another non-limiting type of alkane that can be used is a mixture of C₁₅ to C₂₀ alkanes having approximately ⅔ branched-chain alkanes and ⅓ cycloalkanes and available commercially under the trade name ISOPAR™ V (CAS#64742-46-7—Exxon Chemical Americas, Houston, Tex.).

The one or more alkanes that can be used in the improved evaporation barrier of the present invention have a density that is less than that of the aqueous phase (e.g., water, saltwater, brine, fracking liquid, etc.), thereby enabling the alkane to float on the aqueous phase. Generally, the density of the alkane or alkane mixture is from 0.73 to 0.86 (and all values and ranges therebetween) (ASTM D5002-94). The one or more alkanes generally have a low viscosity and a low vapor pressure; however, this is not required. As defined herein, low viscosity is less than 1000 mPa-s at room temperature, and typically from 20-400 mPa-s (ASTM D7042-04). Low vapor pressure is defined as less than 5 mmHg at room temperature (e.g., 77° F. or 25° C.). The following non-limiting non-volatile oils have low vapor pressure at room temperature: paraffin oil (<0.5 mmHg), vegetable oil (<1 mmHg), silicone oil (<5 mmHg). The vapor pressure is measured by ASTM D323 (Reid Method)), and is generally combustible rather than flammable liquids in atmospheric conditions (e.g., Earth's atmosphere at sea level); however, this is not required.

In addition to the characteristics of the alkanes described above, the one or more alkanes can have additional properties which enhance the features and properties of the improved evaporation barrier of the present invention. For example, the alkane can optionally have a melting point below room temperature, thereby making the alkane more easily dispersible in an aqueous phase (e.g., water, saltwater, brine, fracking fluid). The alkane can optionally have a low viscosity (e.g., less than 1000 mPa-s), thereby also making the alkane more easily dispersible in an aqueous phase (e.g., water, saltwater, brine, fracking fluid). When the alkane is or includes a wax, the wax is generally heated until the wax melts when mixing the wax with oil. The resulting mixture (up to 40 wt. % wax) remains liquid at room temperature (e.g., 77° F.) with suitable viscosity (e.g., 20-1000 mPa-s). The one or more alkanes are generally readily available, generally inexpensive, and available in high purity, thus making the use of such alkanes desirable in the improved evaporation barrier of the present invention.

It is noted that although an evaporation barrier can be formulated to only include alkanes (however, this is not required), when only the alkanes are used, the alkanes tend to smoke at temperatures of 90° C. or above. Such smoking indicates that the protective layer provided by the alkane evaporates at elevated temperatures, thereby resulting in the eventual loss of protection of the evaporation barrier.

Non-Volatile Oil

As used herein, the term “non-volatile oil” is used to refer to oils which can be heated to the boiling point of water without significant evaporation (e.g., less than 1% loss over a 30 minute period at 100° C.) and which can be the water-insoluble liquid. The non-volatile oil generally has a boiling point in excess of 200° C.; however, this is not required. The non-volatile oil generally is capable of forming a uniform mixture with the alkane. The non-volatile oils can include one or more of silicone oils, vegetable oils, mineral oils, and other oils having similar properties. In one non-limiting embodiment, the non-volatile oil is one or more vegetable oils. In another non-limiting embodiment, the non-volatile oil is one or more silicone oils. In another non-limiting embodiment, the non-volatile oil is a mixture of one or more silicone oils and one or more vegetable oils and/or one or more mineral oils.

As used herein, the term “vegetable oil” is used in its everyday sense and refers to the oil of any plant whether the oil is derived from a vegetable or a fruit. The vegetable oil is generally a refined, edible oil and can be derived from, for example, rapeseed (canola), soybean, safflower, sunflower, corn, cottonseed, palm, sesame, and olive, etc. However, any vegetable oil which can be heated to the boiling point of water without significant evaporation (e.g., less than 1% loss over a 30 minute period at 100° C.) is suitable. A further benefit of the use of one or more vegetable oils in the improved evaporation barrier of the present invention is that vegetable oil is generally safe and nontoxic, thus minimizing or eliminating safety and toxicity issues that might be factors with other compounds having similar physical properties. The vegetable oils are also readily available in large quantity and are relatively inexpensive. Generally, the vegetable oil is one that is suitable for deep frying applications. One non-limiting example is low erucic acid canola oil. Such low erucic acid canola oil has excellent resistance to oxidation and to thermal breakdown.

Silicone oils are commercially available from a number of sources including from Sigma Chemical Company, Saint Louis, Mo. (Product No.: M6884, CAS No.: 8020-83-5). When silicone oil is used, the silicone oil generally has a low viscosity, generally below 200 centipoise (cP) at 25° C. (ASTM D7042-04), and typically less than 30-50 cP, and more typically less than 10-15 cP. The non-volatile oil can be only silicone oil, or can be a mixture of one or more silicone oils with one or more mineral oils and/or one or more vegetable oils; however, this is not required.

The non-volatile oil can be or include one or more mineral oils (e.g., paraffin oil, etc.); however, this is not required.

Reflective Material

A reflective material can optionally be added to the improved evaporation barrier of the present invention to create an added physical barrier to evaporation and to reflect solar radiation to inhibit or prevent heating of the aqueous phase (e.g., water, saltwater, brine, fracking liquid, etc.). The improved evaporation barrier can include a reflective material and no non-reflective material, or include both a reflective and non-reflective material. In one non-limiting embodiment, the reflective material includes a) aluminum, aluminum alloy, magnesium and/or magnesium alloy powder having an average particle size of generally 0.01-200 microns (and all values and ranges therebetween), and/or b) aluminum, aluminum alloy, magnesium and/or magnesium alloy flakes having an average size of 1 micron or less in average thickness by about 60-200 microns in average diameter (and all values and ranges therebetween). The reflective material can also or alternatively include microballs or microballoons (e.g., aluminum-coated 3M Scotchlight™ glass microballoons, etc.); however, this is not required. The reflectance or reflectivity of the reflective material is generally greater than 70%, typically at least 80-90%, and more typically greater than 90% for solar radiation, particularly in the visible and near-IR wavelength ranges, and generally greater than 60%, and typically greater than 80-90% for the long wavelength (far) IR wavelengths. The transmittance of the reflective material is generally less than 20%, typically less than 10%, and more typically less than 5%.

Aluminum, magnesium, and their alloys are desirable reflector materials, but other reflective materials, including glass and engineered pigments such as TiO₂, ZrO₂, etc., can be used. White reflective pigments (such as ZnO, TiO₂, etc.) have high diffuse reflectivity, while metals (such as aluminum or magnesium) have high specular reflection. Generally, the reflective liquid coating or pigment should have a reflectance of greater than 75%, and typically greater than 80-90%. One or more types of non-reflective material can be used in the improved evaporation barrier of the present invention.

Non-Reflective Material

A non-reflective material can optionally be added to the improved evaporation barrier of the present invention to create an added physical barrier to evaporation and to reflect solar radiation to inhibit or prevent heating of the aqueous phase (e.g., water, saltwater, brine, fracking liquid, etc.). The improved evaporation barrier can only include a non-reflective material or include both a reflective and non-reflective material. The non-reflective material can be a material such as an optically transparent or translucent material such as glass or polymeric flakes, glass, ceramic, or polymeric microballoons and/or microballs, silica, mica, or other translucent or transparent particle. The density of the non-reflective material can be greater than, equal to, or less than the density of water (i.e., 1 g/cc). The size of the non-reflective material is generally 0.01-200 microns (and all values and ranges therebetween). A non-reflective material is defined as a material that has at least 30% transmittance (e.g., at least 30% of the electromagnetic radiation passes through the through the material) (ASTM: D1003, ASTM C1649). The non-reflective material typically has a transmittance of up to 99% (e.g., 30-99% transmittance and all values and ranges therebetween), typically at least 40% transmittance, and more typically at least 65% transmittance. One or more types of non-reflective material can be used in the improved evaporation barrier of the present invention.

Coupling Agent

The reflective material or non-reflective material can optionally be functionalized with a lipophilic and/or hydrophobic coupling agent, generally through the use of a silane coupling agent, such that the reflective particle or element is wetted by and remains suspended in the hydrocarbon phase (e.g., water-insoluble liquid), even when the improved evaporation barrier of the present invention is dispersed in the aqueous phase (e.g., water, saltwater, brine, fracking fluid). The reflective material or non-reflective material can be coated with silane compound. The silane compound generally constitutes about 0.1-3 wt. % of the coated particle (and all values and ranges therebetween). The coating thickness can be about 10-500 nm (and all values and ranges therebetween). The coating process is generally by deposition of the silane compound from aqueous solution; however, other coating methods can be used. When the reflective material or non-reflective material may be heavier than aqueous phase (e.g., water, saltwater, brine, fracking liquid, etc.) and the oil, the reflective material or non-reflective material generally settles to the water-oil interface of the improved evaporation barrier of the present invention when dispersed in the aqueous phase, thus inhibiting or preventing the reflective material or non-reflective material from sinking to the bottom of the aqueous phase. Surface tension is thus relied upon to maintain the reflective material or non-reflective material at the surface of the aqueous phase. With the hydrophobic nature of the silicone coupling agent, combined with its lipophilic nature, the reflective material or non-reflective material remains suspended at the oil-water interface indefinitely or for extended periods of time (e.g., greater than 7 days).

Other methods of creating reflective interfaces are also familiar to those in the art, including through use of liquid interfaces with differing indexes of refraction. When certain ratios are obtained, normally using dielectric liquids (which can also be created using dielectric/optical nanoparticles), complete reflection can be achieved. When this is done with two immiscible liquid phases (one of which may be the aqueous phase), high reflectivity can be achieved. If the liquid phases are created in a stable dispersion, they can be quite effective in producing a reflective or otherwise opaque coating while not presenting any potential for pore blockage if introduced into a wellbore.

Hydrophobic Compound

A hydrophobic compound can optionally be included in the improved evaporation barrier of the present invention. One non-limiting hydrophobic compound that can be used includes surfactant; however, other or additional types of hydrophobic compound can be used (e.g., wetting agents, detergents, solubilizers, soaps, etc.). The desirable properties of the surfactant (when used) are in part influenced by the overall balance between the hydrophilic portion of the molecule and the lipophilic portion of the molecule (which can be described in terms of an overall numerical value called the HLB number [hydrophilic-lipophilic balance]) which serves as a guide to the behavior of the surfactant in aqueous or oil solutions. Surfactants with HLB values of greater than 10 are predominantly hydrophilic; surfactants with HBL values below 10 (but above zero) are predominantly lipophilic. When a surfactant is included in the improved evaporation barrier of the present invention, the HLB value is generally from 5 and 15 (and all values and ranges therebetween); however, any surfactant producing the desired effect of partitioning at the aqueous/oil interface is suitable for use in the improved evaporation barrier of the present invention.

The surfactant (when used) is generally compatible with oil and gas operations. Non-limiting examples of surfactant that can be used in the improved evaporation barrier of the present invention are polyoxyethylenesorbitans and/or polyoxyethylene ethers. Other non-limiting examples of surfactant that can be used in the improved evaporation barrier of the present invention are surfactants sold under the tradename BRIJ™ (e.g., polyoxyethylene 10 oleyl ether (sold under the tradename BRIJ™ 96, CAS#9004-98-2, Sigma Chemical Company, St. Louis, Mo.) which has an HLB value of approximately 12.4).

Improved Evaporation Barrier

The improved evaporation barrier of the present invention is generally formed of a liquid and is a mixture of an alkane, a non-volatile oil, and one or more reflective materials and/or non-reflective materials (which can optionally be surface functionalized with a coupling agent), and optionally a hydrophobic compound (e.g., surfactant). The improved evaporation barrier of the present invention can be prepared first by mixing the alkane and non-volatile oil (e.g., non-volatile oil, wax and non-volatile oil) and optional surfactant. Once this mixture is prepared, the reflective material and/or non-reflective material can be added to the mixture to form the improved evaporation barrier of the present invention. The reflective material and/or non-reflective material can be dispersed using any suitable method that breaks their surface tension and agglomerations such that they become fully wetted and dispersed in the alkane/non-volatile oil/optional surfactant mixture. The reflective material and/or non-reflective material is typically added in a quantity such that the overall density of the improved evaporation barrier of the present invention remains below the density of the aqueous phase (e.g., water, saltwater, brine, fracking fluid), such that upon dispersion into the aqueous phase, the improved evaporation barrier of the present invention separates and floats to the surface of the aqueous phase.

Preparation of the Improved Evaporation Barrier

The improved evaporation barrier of the present invention can be prepared by mixing appropriate proportions of the alkane and the non-volatile oil. If present in the mixture, the appropriate amount of surfactant is then added and mixing is continued until the surfactant is fully dissolved in the alkane/non-volatile oil mixture. Thereafter, the reflective material and/or non-reflective material can be added to the mixture. Following mixing, the improved evaporation barrier liquid can be stored at room temperature in a container (e.g., a clear or opaque glass bottle or container, plastic bottle or container, drum, etc.).

Use of the Improved Evaporation Barrier

The improved evaporation barrier of the present invention can be used by dispensing a sufficient amount of the liquid improved evaporation barrier to cover the aqueous phase. The improved evaporation barrier is generally added to the aqueous phase in a pond, lake, reservoir, retention tank, etc. to form a continuous film on the surface of the aqueous phase that has a thickness of at least about 0.05 microns (0.00005 mm). In one non-limiting embodiment, the thickness of the improved evaporation barrier of the present invention on the surface of the aqueous phase is generally about 0.05-5,000 microns (and all values and ranges therebetween). Generally, the thickness of the film is no more than 2 mm (2000 microns), and typically no more than 1 mm (1000 microns). In another non-limiting embodiment, the thickness of the improved evaporation barrier of the present invention on the surface of the aqueous phase is about 5-300 microns. In another non-limiting embodiment, the thickness of the improved evaporation barrier of the present invention on the surface of the aqueous phase is about 25-150 microns. In another non-limiting embodiment, the thickness of the improved evaporation barrier of the present invention on the surface of the aqueous phase is about 25-100 microns (0.001″-0.004″).

The impermeable solid is added to the water-insoluble liquid to form the improved evaporation barrier of the present invention and the improved evaporation barrier is dispersed into a film on the surface of the aqueous phase (e.g., water, saltwater, brine, fracking fluid in a pond, reservoir, retention tank, etc.) to inhibit or prevent evaporation of the aqueous phase. The impermeable solid is generally present in the improved evaporation barrier in sufficient concentration to cover at least 30% (e.g., 30-100% and all values and ranges therebetween) of the surface area an aqueous phase when the improved evaporation barrier is added to the aqueous phase. In one non-limiting embodiment, the impermeable solid is generally present in sufficient concentration in the improved evaporation barrier to cover 50-75% of the surface area of an aqueous phase when the improved evaporation barrier is added to the aqueous phase.

The impermeable solid can be arranged in a monolayer or multilayer fashion on or at the surface of the aqueous phase when the improved evaporation barrier is added to the aqueous phase. In one non-limiting embodiment, the impermeable solid is primarily arranged in a monolayer fashion when the improved evaporation barrier is added to the aqueous phase.

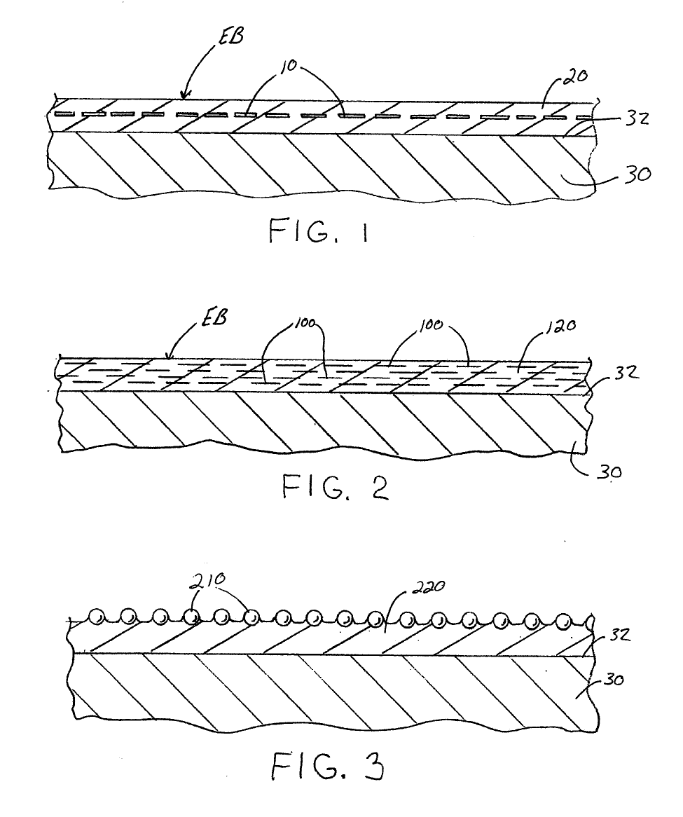

Area coverage from the impermeable solid, as well as surface tension forces and dispersion of the impermeable solid, are illustrated in FIGS. 1-3. In one non-limiting embodiment, about 30-100% of the impermeable solid is in the form of flakes. It has been found that flakes provide excellent coverage at the lowest concentration or amount in the improved evaporation barrier.

The film on the surface of the aqueous phase that is formed by the improved evaporation barrier is formulated to block at least 60% of water evaporation from the aqueous phase in a pond, lake, reservoir, retention tank, etc. at a temperature up to about 85° C. where the film remains intact on the surface of the aqueous phase. In one non-limiting embodiment, the film on the surface of the aqueous phase that is formed by the improved evaporation barrier is formulated to block at least 80% of water evaporation from the aqueous phase in a pond, lake, reservoir, retention tank, etc. at a temperature up to about 85° C. where the film remains intact on the surface of the aqueous phase, and typically the film on the surface of the aqueous phase that is formed by the improved evaporation barrier is formulated to blocks at least 95% of water evaporation from the aqueous phase in a pond, lake, reservoir, retention tank, etc. at a temperature up to about 85° C. where the film remains intact on the surface of the aqueous phase.

The film on the surface of the aqueous phase that is formed by the improved evaporation barrier is generally formulated to allow for the passage of trapped gasses and bubbles (which pass through the film as gas bubbles due to the density of the gas and film) to pass upwardly through the film. The film is also generally formulated to allow for the passage of water droplets or puddles (such as water from rain or water from a hose) to pass downwardly through the film and into the aqueous phase in a pond, lake, reservoir, retention tank, etc.

FIG. 1 illustrates an improved evaporation barrier EB formed of a dispersion of glass flakes 10 as the impermeable solid in a water-insoluble liquid 20, wherein flakes cover at least 80% of the total surface area of the top surface 32 aqueous phase 30. The flakes can be formed of glass, metal, and/or some other type of material. The flakes can have generally the same size, shape and dimensions; however, this is not required. The flakes are illustrated as being generally located half-way between the top and bottom surface of the water-insoluble liquid; however, this is not required. The flakes are added in a quantity to the water-insoluble liquid such that a single layer of flakes forms in the evaporation barrier after the evaporation barrier has been added to the aqueous phase 30.

FIG. 2 illustrates an improved evaporation barrier EB formed of multiple layers of flakes 100 dispersed in a water-insoluble liquid 120, wherein the flakes cover at least 80% of the total surface area of the top surface 32 aqueous phase 30. The flakes can be formed of glass, metal, and/or some other type of material. The flakes can have generally the same size, shape and dimensions; however, this is not required. The flakes are illustrated as being dispersed generally evenly between the top and bottom surface of the water-insoluble liquid; however, this is not required. The flakes are added in a quantity to the water-insoluble liquid such that multiple layers of flakes form in the evaporation barrier after the evaporation barrier has been added to the aqueous phase 30. The number of formed layers is non-limiting.

FIG. 3 illustrates an improved evaporation barrier EB formed of microballoons and/or microballs 210 as the impermeable solid dispersed in a water-insoluble liquid 220. The microballoons and/or microballs can be formed of glass, metal, and/or some other type of material. The microballoons and/or microballs can have generally the same size, shape and dimensions; however, this is not required. The microballoons and/or microballs are illustrated as being dispersed on the top surface of the water-insoluble liquid; however, this is not required. The microballoons and/or microballs are added in a quantity to the water-insoluble liquid such that a single layer of microballoons and/or microballs form on the top surface of evaporation barrier after the evaporation barrier has been added to the aqueous phase 30; however, it can be appreciated that the microballoons and/or microballs can be added in a quantity to the water-insoluble liquid such that multiple layers of microballoons and/or microballs form at, near, or on the top surface of the evaporation barrier after the evaporation barrier has been added to the aqueous phase 30. The number of formed layers is non-limiting. Generally, the microballoons and/or microballs are added in a quantity to the water-insoluble liquid such that the microballoons and/or microballs cover at least 50% of the top surface area of the top surface 32 aqueous phase 30.

The improved evaporation barrier of the present invention can be easily floated over the aqueous phase by simply dumping a bucket or barrel, or pumping the liquid improved evaporation barrier of the present invention onto or into a pond, basin or above-ground storage container that contains the aqueous phase. In addition, because of the dynamic nature of the improved evaporation barrier of the present invention, additional aqueous phase (e.g., water, saltwater, brine, fracking liquid, etc.) can be added in any manner (such as rain, pipe outflow, etc.) to the pond, basin or above-ground storage container that already contains the improved evaporation barrier of the present invention without damaging or impairing the effectiveness of the improved evaporation barrier of the present invention on the surface of the aqueous phase.

The general formulation of the improved evaporation barrier is as follows in volume percent:

| Ingredient | Ex. A | Ex. B | Ex. C | Ex. D |
|---|---|---|---|---|
| Water-Insoluble Liquid | 60-99.5% | 65-99.5% | 70-99% | 75-99% |
| Impermeable Solid | 0.5-40% | 0.5-35% | 1-30% | 1-25% |
| Hydrophobic Compound | 0-4% | 0-4% | 0-4% | 0-4% |
| Coupling Agent | 0-4% | 0-2% | 0-4% | 4-4% |
| Ingredient | Ex. E | Ex. F | Ex. G | Ex. H |
| Water-Insoluble Liquid | 75-98% | 80-98% | 80-97% | 82-97% |
| Impermeable Solid | 1-20% | 1-20% | 1-20% | 1-20% |
| Hydrophobic Compound | 0-3% | 0-3% | 0-2 | 0-2% |
| Coupling Agent | 0-2% | 0-2% | 0-2% | 0-2%. |
| Ingredient | Ex. I | Ex. J | Ex. K | Ex. L |
| Water-Insoluble Liquid | 85-99.5% | 90-95% | 90-95% | 91-94% |
| Impermeable Solid | 0.1-13% | 0.4-12% | 0.5-11% | 3-10% |
| Hydrophobic Compound | 0-4% | 0-2% | 0.05-2% | 0.1-1% |
| Coupling Agent | 0-2% | 0.05-1% | 0.1-1% | 0.1-0.5% |
| Ingredient | Ex. M | Ex. N | Ex. O | Ex. P |
| Non-volatile Oil | 95.2% | 99.1% | 91.4% | 93.7% |
| Reflective/Non-reflective material | 4.5% | 0.6% | 9.3% | 5.8% |
| Surfactant | 0.15% | 0.15% | 0 | 0.15% |
| Silane Compound | 0.15% | 0.15% | 0.3% | 0.35%. |

The invention is further illustrated by the following specific but non-limiting examples.

### Example 1—Preparation of Improved Evaporation Barrier

In one non-limiting embodiment of the invention, an improved evaporation barrier was prepared as described below.

0.5 liter of paraffin oil was blended with 0.25 liters of vegetable oil. 1 gram of surfactant (polyoxyethylene 10 oleyl ether) was added as a powder and the mixture was stirred until uniform. 30 grams of 1 micron by 60 micron aluminum flakes were prepared by coating with a silane coupling agent. The flakes were blended with the paraffin oil mixture using a high shear blender.

### Example 2—Preparation of Improved Evaporation Barrier

In another non-limiting embodiment of the invention, an improved evaporation barrier was prepared as described below.

A mixture of ISOPAR™ V oil and canola oil was prepared as described in Example 1. Following mixing, 1 gram of the surfactant polyoxyethylene 10 oleyl ether (CAS#9004-98-2, sold under the tradename BRIJ™ 96; Sigma Chemical Company, St. Louis, Mo.) was added to the alkane/non-volatile oil mixture and mixing was continued at room temperature (77° F.) until all of the surfactant was fully dissolved (about 10 minutes). 60 grams of H-2 aluminum powder (Valmet Inc.) was surface prepared with a silane coupling agent and added to the mixture using a high shear vortex mixer until completely dispersed.

### Example 3—Preparation of Improved Evaporation Barrier

In another non-limiting embodiment of the invention, an improved evaporation barrier was prepared as described below.

A mixture of silicon oil and mineral oil was prepared as described as follows: 0.5 liter of paraffin oil is blended with 0.25 liters of silicon oil. Following mixing, 40 grams of ×60 aluminum flakes were surface prepared with a silane coupling agent and added to the mixture using a high shear vortex mixer and ultrasound sonication until completely dispersed.

### Example 4—Preparation of Improved Evaporation Barrier

In another non-limiting embodiment of the invention, an improved evaporation barrier was prepared as described below.

A mixture of ISOPAR™ V oil and canola oil is prepared as described in Example 1. Following mixing, 1 gram of the surfactant polyoxyethylene 10 oleyl ether (CAS#9004-98-2, sold under the tradename BRIJ™ 96; Sigma Chemical Company, St. Louis, Mo.) was added to the alkane/non-volatile oil mixture and mixing was continued at room temperature until all of the surfactant was fully dissolved (about 10 minutes). 4 grams of aluminum-coated 3M Scotchlight™ glass microballoons and/or microballs were surface prepared with a silane coupling agents and added to the mixture using a high shear vortex mixer until completely dispersed.

### Example 5—Preparation of Improved Evaporation Barrier

In another non-limiting embodiment of the invention, an improved evaporation barrier was prepared as described below.

A mixture of 0.5 liter of paraffin oil was blended with 0.25 liters of vegetable oil. 0-1 gram of surfactant (polyoxyethylene 10 oleyl ether) was added as a powder and the mixture was stirred until uniform. 30 grams of 1 micron non-reflective glass microballoons were added and blended with the paraffin oil mixture using a high shear blender.

### Example 6—Preparation of Improved Evaporation Barrier

In one non-limiting formulation of the improved evaporation barrier, there is provided an impermeable solid in the form of glass flakes having a particles size of approximately 150 microns in diameter by 3-10 microns thick. The surface of the glass flakes is surface treated with about 0.75 wt. % ethyltrimethoxysilane. The surface treated glass flakes are then added to a water-insoluble liquid that is formed of 50 wt. % paraffin oil, 40 wt. % soybean oil, and 10 wt. % or low viscosity silicone oil (PDMS). The glass flakes constitute about 8 wt. % of the improved evaporation barrier. About 0.3 wt. % sodium laurate is added as a surfactant to the improved evaporation barrier. The improved evaporation barrier was added to an aqueous phase such as 3 wt. % KCl brine in a retention tank to form a film of improved evaporation barrier on the surface of the aqueous phase having a thickness of 0.2 mm. The film formed by the evaporation resistant coating was transparent or nearly transparent. The film formed by the evaporation resistant coating blocked at least 95% of water evaporation from the 3 wt. % KCl brine in a retention tank at a temperature of 35° C.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall there between. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

1. An evaporation barrier formulated to be added to an aqueous phase so as to inhibit evaporation of the aqueous phase, said evaporation barrier comprising:
a water-insoluble liquid having a density of less than 1 g/cc; and,
an impermeable solid material, wherein said impermeable solid material is a flake, particle, microballoon, and/or microball, at least 20% of said impermeable solid material remains suspended in said water-insoluble liquid for at least 1 day after being mixed with said water-insoluble liquid.

2. The evaporation barrier as defined in claim 1, wherein said water-insoluble liquid has a viscosity of less than 400 cP at 25° C.

3. The evaporation barrier as defined in claim 1, wherein said impermeable solid material is at a concentration of 0.5-25 vol. % of said evaporation barrier.

4. The evaporation barrier as defined in claim 1, wherein at least 20% of said impermeable solid material is at least partially retained in said water-insoluble liquid when said evaporation barrier is added to said aqueous phase.

5. The evaporation barrier as defined in claim 1, wherein said impermeable solid material includes materials that have a reflectiveness of at least 50% in UV and/or IR ranges.

6. The evaporation barrier as defined in claim 1, wherein said impermeable solid material includes non-reflective materials that have a transmittance of at least 30% in the optical wavelengths.

7. The evaporation barrier as defined in 1, wherein said impermeable solid material includes one or more non-reflective materials selected from the group consisting of an optically transparent or translucent material such as glass or polymeric flakes, glass, ceramic, or polymeric microballoons and/or microballs, silica, and mica.

8. The evaporation barrier as defined in claim 1, wherein said impermeable solid material includes one or more materials selected from group of mica flakes, glass flakes, glass microspheres, ceramic microspheres, polymer flakes, polymer microspheres, calcite, gypsum/selenite, lucite, magnesium carbonate, zeolite, montmotillionite, kaolin, feldspar, polypropylene, polyacytal, and acrylic.

9. The evaporation barrier as defined in claim 1, wherein said impermeable solid material includes one or more reflective materials selected from the group consisting of aluminum, aluminum alloy, magnesium, magnesium alloy, metallized particle, material coated with a reflective pigment, microballoon, coated microballoon, microball, and coated microball.

10. The evaporation barrier as defined in claim 9, wherein said reflective material includes one or more materials selected from the group consisting of aluminum particles, aluminum flakes, aluminum alloy particles, aluminum alloy flakes, magnesium particles, magnesium flakes, magnesium alloy particles.

11. The evaporation barrier as defined in claim 9, wherein said reflective material has a reflectance of at least 75% in the visible wavelengths and at least 50% in the long IR wavelengths.

12. The evaporation barrier as defined in claim 9, wherein at least a portion of said reflective material degrades by at least 10% within 360 days upon exposure to water, saltwater or brine at a temperature of at least 90° F.

13. The evaporation barrier as defined in claim 1, wherein the impermeable solid material at least partially reacts in the aqueous phase to produce gas bubbles on an outer surface of said impermeable solid material which creates additional buoyancy of said impermeable solid material in the aqueous phase.

14. The evaporation barrier as defined in claim 1, wherein said impermeable solid material includes one or more materials having a density of greater than 1 g/cc.

15. The evaporation barrier as defined in claim 1, wherein said impermeable solid material includes one or more materials having a density of no greater than 3 g/cc.

16. The evaporation barrier as defined in claim 1, wherein said impermeable solid material includes one or more materials having a density of less than 1 g/cc.

17. The evaporation barrier as defined in claim 1, wherein said water-insoluble liquid has a vapor pressure of less than 0.1 torr at 80° C.

18. The evaporation barrier as defined in claim 1, wherein said water-insoluble liquid has a solubility in water that is less than 1000 ppm solubility.

19. The evaporation barrier as defined in claim 1, wherein said water-insoluble liquid has a solubility in water such that a water content in the water-insoluble liquid at a temperature of about 2580° C. is less than 5 vol. %.

20. The evaporation barrier as defined in claim 1, wherein said water-insoluble liquid includes one or more components selected from the group of hydrocarbons (e.g., alkanes, from C8-C30, including paraffin oils, mineral oils, JP8, fuel oil, heating oil, vegetable oil such as soybean oil, linseed oil, canola oil, or other vegetable oil, etc.), silicones, silicon oil, and mineral oil; said hydrocarbons including one or more compounds selected from the group consisting of alkane and hydrocarbon chains of C8-C30, said hydrocarbon chains of C8-C30 including one or more materials selected from the group consisting of paraffin oil, mineral oil, kerosene-based fuel, fuel oil, heating oil, and vegetable oil.

21. The evaporation barrier as defined in claim 1, wherein said water-insoluble liquid has a viscosity of less than about 10,000 cP at 25° C.

22. The evaporation barrier as defined in claim 1, wherein said impermeable solid material is treated with a coupling agent to form a hydrophobic or organophilic surface on an outer surface of said impermeable solid material.

23. The evaporation barrier as defined in claim 22, wherein said coupling agent includes one or more materials selected from the group consisting of silane, silicone, siloxane, and silizane.

24. The evaporation barrier as defined in claim 1, including a surfactant.

25. The evaporation barrier as defined in claim 24, wherein said surfactant includes one or more components selected from linear alkylbenzenesulfonates, lignin sulfonates, fatty alcohol ethoxylates, alkylphenol ethoxylates, ammonium lauryl sulfate, sodium lauryl sulfate, dioctyl sodium sulfosuccinate (DOSS), sorbitan monooleate (Span 80), and polyoxyethylenated sorbitan monooleate.

26. The evaporation barrier as defined in claim 1, including antimicrobial particles or antimicrobial medium soluble in said water-insoluble liquid.

27-33. (canceled)

34. An evaporation barrier formulated to be added to an aqueous phase so as to inhibit evaporation of the aqueous phase so as to block at least 60% of water evaporation from the aqueous phase at a temperature up to about 85° C. where said evaporation barrier forms a continuous film on a top surface of said aqueous phase, said aqueous phase is water, saltwater, brine, or fracking fluid that is located in a pond, tank, retention pond, reservoir, basin, lake, open retention container, or storage container for use in oil and gas operations, said evaporation barrier comprising:
a water-insoluble liquid having a density of less than 1 g/cc, said water-insoluble liquid has a viscosity of less than 400 cP at 25° C., said water-insoluble liquid includes one or more components selected from the group of hydrocarbons (e.g., alkanes, from C8-C30, including paraffin oils, mineral oils, JP8, fuel oil, heating oil, vegetable oil such as soybean oil, linseed oil, canola oil, or other vegetable oil, etc.), silicones, silicon oil, and mineral oil; said hydrocarbons including one or more compounds selected from the group consisting of alkane and hydrocarbon chains of C8-C30, said hydrocarbon chains of C8-C30 including one or more materials selected from the group consisting of paraffin oil, mineral oil, kerosene-based fuel, fuel oil, heating oil, and vegetable oil; and,
an impermeable solid material, said impermeable solid material is a flake, particle, microballoon, and/or microball, said impermeable solid material is at a concentration of 0.5-40 vol. % of said evaporation barrier, at least 20% of said impermeable solid material remains suspended in said water-insoluble liquid for at least one day after being mixed with said water-insoluble liquid.

35. The evaporation barrier as defined in claim 34, wherein said impermeable solid material includes a) materials that have a reflectiveness of at least 50% in UV and/or IR ranges, and/or b) non-reflective materials that have a transmittance of at least 30% in the optical wavelengths.

36. The evaporation barrier as defined in 34, wherein said impermeable solid material includes a) one or more non-reflective materials selected from the group consisting of an optically transparent or translucent material such as glass or polymeric flakes, glass, ceramic, or polymeric microballoons and/or microballs, silica, and mica, b) one or more materials selected from the group of mica flakes, glass flakes, glass microspheres, ceramic microspheres, polymer flakes, polymer microspheres, calcite, gypsum/selenite, lucite, magnesium carbonate, zeolite, montmotillionite, kaolin, feldspar, polypropylene, polyacytal, and acrylic, c) one or more reflective materials selected from the group consisting of aluminum, aluminum alloy, magnesium, magnesium alloy, metallized particle, material coated with a reflective pigment, microballoon, coated microballoon, microball, and coated microball, and/or d) one or more materials selected from the group consisting of aluminum particles, aluminum flakes, aluminum alloy particles, aluminum alloy flakes, magnesium particles, magnesium flakes, and magnesium alloy particles.

37. The evaporation barrier as defined in 35, wherein said impermeable solid material includes a) one or more non-reflective materials selected from the group consisting of an optically transparent or translucent material such as glass or polymeric flakes, glass, ceramic, or polymeric microballoons and/or microballs, silica, and mica, b) one or more materials selected from the group of mica flakes, glass flakes, glass microspheres, ceramic microspheres, polymer flakes, polymer microspheres, calcite, gypsum/selenite, lucite, magnesium carbonate, zeolite, montmotillionite, kaolin, feldspar, polypropylene, polyacytal, and acrylic, c) one or more reflective materials selected from the group consisting of aluminum, aluminum alloy, magnesium, magnesium alloy, metallized particle, material coated with a reflective pigment, microballoon, coated microballoon, microball, and coated microball, and/or d) one or more materials selected from the group consisting of aluminum particles, aluminum flakes, aluminum alloy particles, aluminum alloy flakes, magnesium particles, magnesium flakes, and magnesium alloy particles.

38. The evaporation barrier as defined in claim 34, wherein said reflective material has a reflectance of at least 75% in the visible wavelengths and at least 50% in the long IR wavelengths.

39. The evaporation barrier as defined in claim 34, wherein at least a portion of said reflective material degrades by at least 10% within 360 days upon exposure to water, saltwater or brine at a temperature of at least 90° F.

40. The evaporation barrier as defined in claim 34, wherein the impermeable solid material at least partially reacts in the aqueous phase to produce gas bubbles on an outer surface of said impermeable solid material which creates additional buoyancy of said impermeable solid material in the aqueous phase.

41. The evaporation barrier as defined in claim 34, wherein said impermeable solid material includes a) one or more materials having a density of greater than 1 g/cc, b) one or more materials having a density of no greater than 3 g/cc, and/or c) one or more materials having a density of less than 1 g/cc.

42. The evaporation barrier as defined in claim 34, wherein said water-insoluble liquid has a vapor pressure of less than 0.1 torr at 80° C.

43. The evaporation barrier as defined in claim 34, wherein said water-insoluble liquid has a solubility in water that is less than 1000 ppm solubility.

44. The evaporation barrier as defined in claim 34, wherein said water-insoluble liquid has a solubility in water such that a water content in the water-insoluble liquid at a temperature of about 25-80° C. is less than 5 vol. %.

45. The evaporation barrier as defined in claim 34, wherein said water-insoluble liquid has a viscosity of less than about 10,000 cP at 25° C.

46. The evaporation barrier as defined in claim 34, wherein said impermeable solid material is treated with a coupling agent to form a hydrophobic or organophilic surface on an outer surface of said impermeable solid material.

47. The evaporation barrier as defined in claim 46, wherein said coupling agent includes one or more materials selected from the group consisting of silane, silicone, siloxane, and silizane.

48. The evaporation barrier as defined in claim 34, including a surfactant.

49. The evaporation barrier as defined in claim 48, wherein said surfactant includes one or more components selected from linear alkylbenzenesulfonates, lignin sulfonates, fatty alcohol ethoxylates, alkylphenol ethoxylates, ammonium lauryl sulfate, sodium lauryl sulfate, dioctyl sodium sulfosuccinate (DOSS), sorbitan monooleate (Span 80), and polyoxyethylenated sorbitan monooleate.

50. The evaporation barrier as defined in claim 34, including antimicrobial particles or antimicrobial medium soluble in said water-insoluble liquid.
